(19) United States
(12) Patent Application Publication
(10) Pub. No.: US 2012/0151836 A1
(43) Pub. Date: Jun. 21, 2012

(54) TREE PROTECTOR

(76) Inventor: David B. Crook, Wonder Lake, IL (US)

(21) Appl. No.: 13/328,770

(22) Filed: Dec. 16, 2011

Related U.S. Application Data
(60) Provisional application No. 61/459,719, filed on Dec. 17, 2010.

(51) Int. Cl. A01G 13/02

(52) U.S. Cl. 47/32.4

(57) ABSTRACT

A tree guard having an adjustable circumference is made up of a plurality of adjacent arcuate panels having opposite longitudinal edge portions adapted to receive fastener assemblies that connect the adjacent arcuate panels to one another. Each arcuate panel has an upstanding or upper portion that is positioned next to the tree trunk and a unitary, outwardly flared skirt portion that depends downwardly from the upper portion.

### CROSS-REFERENCE TO RELATED APPLICATION

This application claims the benefit of U.S. Provisional Patent Application Ser. No. 61/459,719 filed on Dec. 17, 2010, the disclosure of which is incorporated by reference herein in its entirety.

### FIELD OF THE INVENTION

This invention relates to devices for shielding tree trunks from injury.

### BACKGROUND OF THE INVENTION

Tree trunks often are at risk to damage by trucks, snowmobiles, all terrain vehicles, and heavy machinery at construction sites or during road repairs and similar activities. The present invention provides a convenient, light weight, relatively inexpensive device that can be installed around the trunk of a tree to provide protection from impact as well as abrasion.

### SUMMARY OF THE INVENTION

A tree guard embodying the features of the present invention is constituted by a plurality of arcuate panels that removably surround the trunk of the tree and are held in place by fastener assemblies between adjacent panels. A relatively wide range of trunk sizes can be accommodated by selecting an appropriate number of panels to circumscribe the trunk.

In particular, the tree guard comprises a plurality of adjacent arcuate panels having opposite longitudinal edge portions that are provided with fastener assembly components which permit coupling of adjacent arcuate panels to one another. Each arcuate panel has an upstanding or upper portion and a unitary, outwardly flared skirt portion that depends downwardly from the upstanding or upper portion.

A wide variety of fastener assemblies can be utilized to removably connect the individual arcuate panels to one another. Preferred are fastener assemblies of snap-in type having male and female end portions.

Preferred materials of construction for the arcuate panels are reaction polymers such as rigid or semi-rigid polyurethane foams; however, other relatively light weight materials can be utilized as well.

### BRIEF DESCRIPTION OF THE DRAWINGS

In the drawings;

FIG. 1 is a perspective view of a tree guard embodying the present invention shown circumscribing a portion of the trunk of a tree;

FIG. 2 is a plan view of FIG. 1;

FIG. 3 is a side elevational view of the tree guard shown in FIG. 1;

FIG. 4 is an exploded perspective view of a tree guard embodying the present invention;

FIG. 5 is a side view of a female-female connector suitable for use in a fastener assembly for coupling adjacent arcuate panels to one another;

FIG. 6 is a side view of a male-female connector suitable for coupling adjacent arcuate panels to one another;

FIG. 7 is a side view of a male-male connector suitable for coupling adjacent arcuate panels to one another; and

FIG. 8 is a side view of an array of male-female connectors suitable for coupling adjacent arcuate panels to one another.

### DESCRIPTION OF PREFERRED EMBODIMENTS

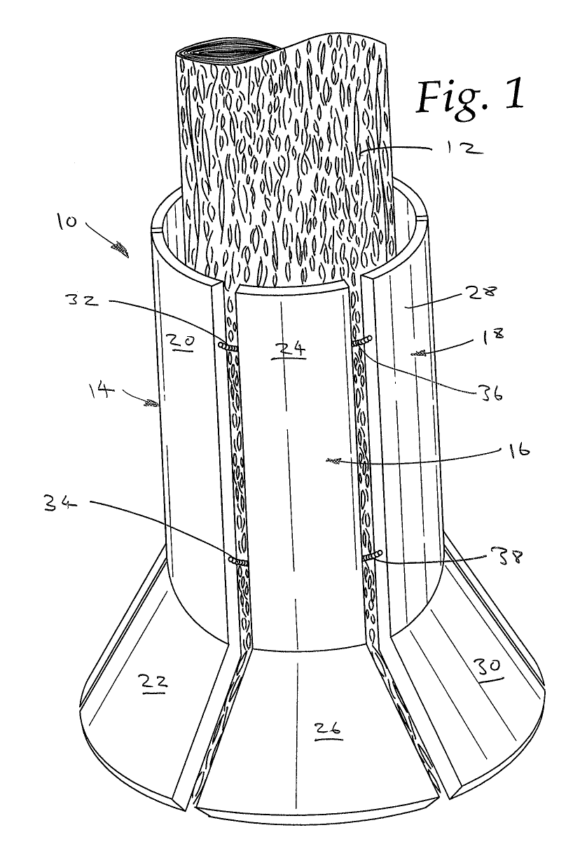

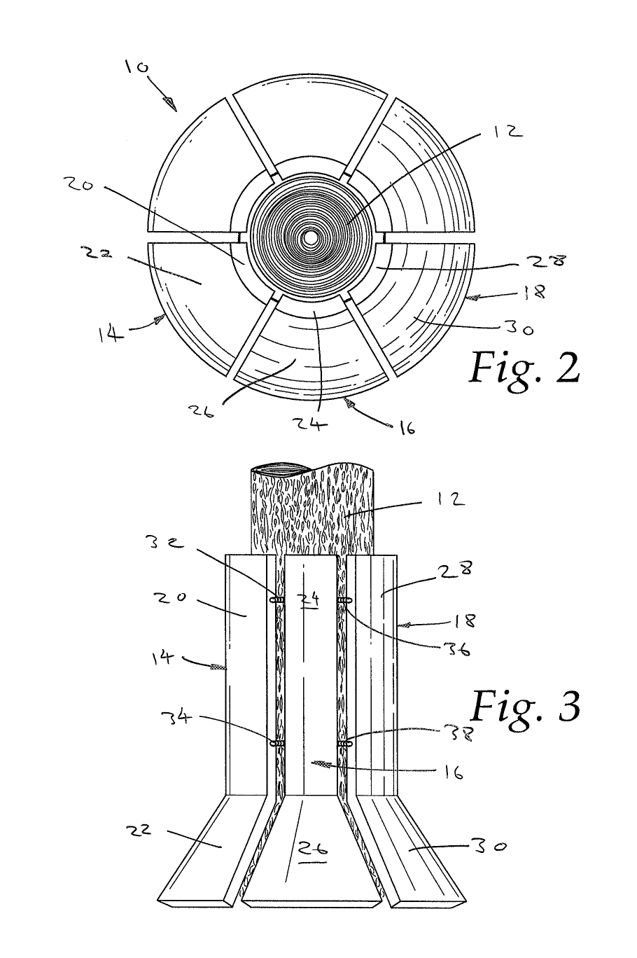

Referring to FIGS. 1, 2 and 3, tree guard 10 is formed around tree trunk 12 by plural arcuate panels such as 14, 16 and 18 that in juxtaposition to and circumscribe trunk 12. The arcuate panels are held in place by upper fastener assemblies such as upper fastener assembly 32 between adjacent panels 14 and 16, and upper fastener assembly 36 between adjacent panels 16 and 18. Lower fastener assemblies 34 and 38 perform a similar function with respect to panels 14, 16 and 18.

Arcuate panel 14 has an upper, or upstanding portion 20 that is positioned close to the trunk 12 and a unitary, outwardly flared skirt portion 20 that depends downwardly from upper portion 20 and extends away from trunk 12. Similarly, arcuate panel 16 has an upper portion 24 positioned close to trunk 12 and a unitary, outwardly flared skirt portion 26 that depends downwardly from upper portion 24 and extends in a direction away from trunk 12. Likewise, arcuate panel 18 has upper portion 28 and skirt portion 30 unitary with upper portion 28. The skirt portion of an arcuate panel preferably defines an included angle with the upper portion of the arcuate panel that is greater than about 135 degrees but less than about 170 degrees. More preferably the included angle is in the range of about 145 degrees to about 155 degrees. An included angle of about 150 degrees is particularly preferred.

The width of the arcuate panels that together form the tree guard can be the same or different as required to accommodate the girth of the tree trunk. For example, an array of alternating wider and narrower panels can be fastened around the tree trunk as the tree guard.

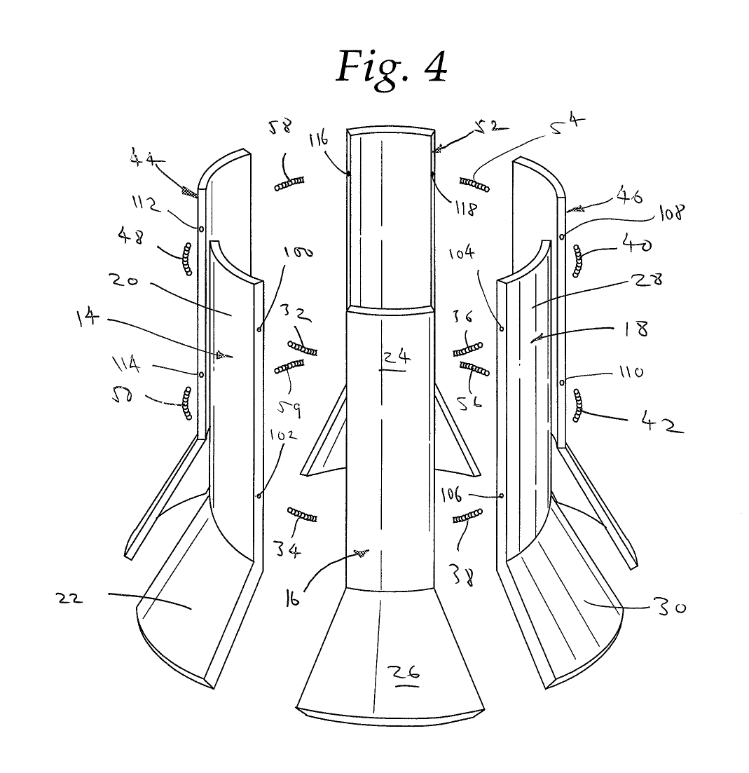

One or more fastener assemblies can be utilized to connect or couple the adjacent arcuate panels. FIG. 4 shows adjacent panels 14 and 16 connected by fastener assemblies 32 and 34, adjacent panels 16 and 18 connected by fastener assemblies 36 and 38, adjacent panels, 18 and 46 connected by fastener assemblies 40 and 42, adjacent panels 40 and 52 connected by fastener assemblies 54 and 56, adjacent panels 14 and 44 connected by fastener assemblies 44 and 50, and adjacent panels 44 and 52 connected by fastener assemblies 58 and 59. Also suitable as fastener assemblies are interlocking belt segments secured to adjacent panels, and the like.

The longitudinal end portion of each arcuate panel defines at least one, preferably two, apertures for receiving a connector of the fastener assembly that keeps adjacent arcuate panels coupled to one another and secured around the tree.

For example, apertures 100 and 102 in arcuate panel 14 are adapted to receive one end portion of respective fastener assemblies 32 and 34 while the opposing longitudinal edge portion of arcuate panel 16 is provided with similar apertures (not shown) adapted to receive the other end portion of fastener assemblies 32 and 34. In a like manner, apertures 104 and 106 in arcuate panel 18 are adapted to receive one end portion of fastener assemblies 36 and 38, apertures 108 and 110 in arcuate panel 46 are adapted to receive one end portion of fastener assemblies 40 and 42. Apertures 112 and 114 in arcuate panel 44 is set with respective fastener assemblies 48 ad 50 in the same manner as do apertures 116 and 118 in arcuate panel 52 with corresponding fastener assemblies 58 and 54.

Fastener assemblies 56 and 59 connect adjacent arcuate panels 44, 52 and 46 in a similar manner.

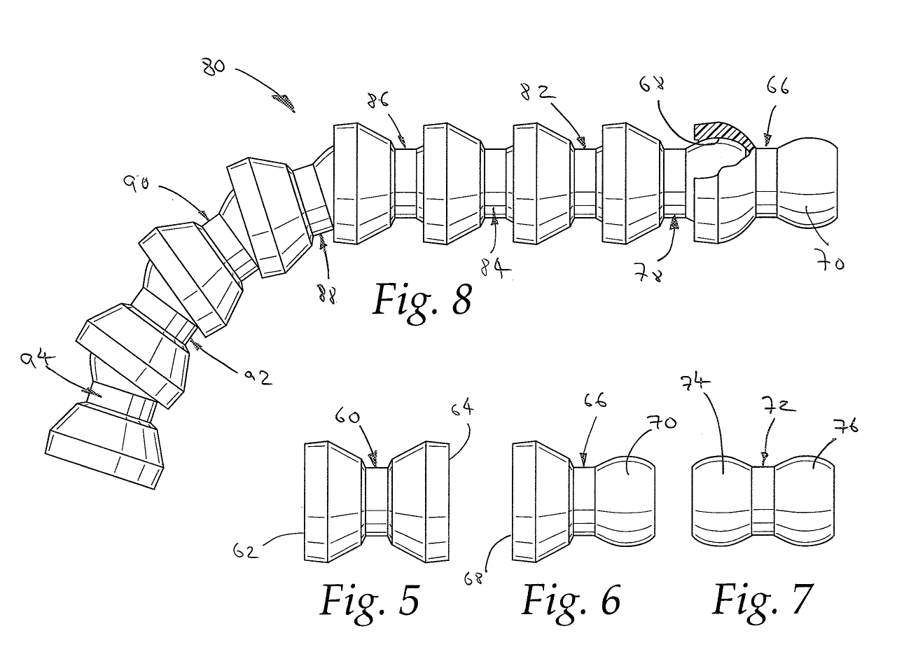

A preferred female-female connector 60 is shown in FIG. 5 and includes opposed sockets 62 and 64 sized to receive a male plug to form a snap-fit connection. A typical male plug is illustrated in FIG. 6 where male-female connector 66 is provided with socket 68 at one end and plug 70 at the other end. FIG. 7 shows a male-male connector 72 provided with opposing plugs 74 and 76.

To provide a spacing between adjacent arcuate panels a plurality of connectors such as those shown in FIGS. 6-7 can be utilized in various combinations to form an array of desired length and thus a desired spacing between adjacent arcuate panels. One such combination of male-female connectors is illustrated in FIG. 8 by connector array 80 which is made up of male-female connectors 66, 78, 82, 84, 86, 88, 90, 92 and 94. Such a connector array has adequate flexibility to conform to the periphery of the tree trunk as needed. A relatively shorter flexible connector array can be formed by inserting the male-male connector 72 shown in FIG. 7 between the female-female connector 60 and female-male connector 66 shown in FIGS. 5 and 6.

If desired, the tree guard panels can have embedded reflectors or a distinctive color, e.g., bright yellow or the like, for safety purposes, or to serve as trail markers for snowmobile and all terrain vehicle trails. Similarly, exposed portions of the fastener assemblies between panels can be provided with a reflective coating for enhanced visibility.

Individual arcuate panels can be fabricated by injection molding using commercially available rigid or semi-rigid polyurethane or polyisocyanurate foam producing compositions. Alternatively, the individual arcuate panels can be fabricated by thermoforming thermoplastic sheets into a desired contour.

The foregoing specification and the drawings are illustrative, but are not to be taken as limiting. Still other variants and arrangements of parts are possible within the spirit and scope of this invention, and will readily present themselves to those skilled in the art.

I claim:

1. A tree guard comprising:
a plurality of adjacent arcuate panels adapted for circumscribing the trunk of the tree, each of the plurality of arcuate panels having opposite longitudinal edge portions, an upper portion, and a unitary outwardly flared skirt portion depending downwardly from the upper portion; and
at least one fastener assembly for coupling each of the adjacent arcuate panels to one another.

2. The tree guard of claim 1 wherein the arcuate panels are connected by opposed male and female connectors embedded in adjacent longitudinal edge portions.

3. The tree guard of claim 1 wherein the arcuate panels are connectable by a male-female-male connector assembly and the male connectors are embedded in adjacent longitudinal edge portions.

4. The tree guard of claim 1 wherein the arcuate panels are connectable by a female-male-female connector assembly and the female connectors are embedded in adjacent longitudinal edge portions.

5. The tree guard of claim 1 wherein the skirt portion defines with the upper portion an included angle greater than about 135 degrees but less than about 170 degrees.

6. The tree guard of claim 1 wherein the skirt portion defines with the upper portion an included angle in the range of about 145 degrees to about 155 degrees.

7. The tree guard of claim 1 wherein the skirt portion defines with the upper portion an included angle of about 150 degrees.

8. The tree guard of claim 1 wherein the arcuate panels are provided with reflectors.

9. A tree guard comprising:
a plurality of adjacent arcuate panels adapted for circumscribing the trunk of the tree, each of the plurality of arcuate panels having opposite longitudinal edge portions, an upstanding portion which terminates at a lower end thereof in a skirt portion;
a pair of fasteners for coupling adjacent arcuate panels to one another so as to surround the trunk, east fastener including complementary male and female connectors; and
the adjacent arcuate panels being secured to one another by said fasteners.

10. The tree guard of claim 9 wherein the arcuate panels are connectable by opposed male and female connectors embedded in adjacent longitudinal edge portions.

11. The tree guard of claim 9 wherein adjacent longitudinal edge portions are provided with embedded female connectors connected therebetween by an intermediate dual male connector.

12. The tree guard of claim 9 wherein adjacent longitudinal edge portions are provided with embedded male connectors connected therebetween by an intermediate dual female connector.
